(19) United States
(12) Patent Application Publication
(10) Pub. No.: US 2014/0298631 A1
(43) Pub. Date: Oct. 9, 2014

(54) TOOL FOR REMOVING PISTON RING

(71) Applicant: CATERPILLAR INC., PEORIA, IL (US)

(72) Inventors: Aaron M. Claver, Congerville, IL (US); Luis A. Vazquez, Peoria, IL (US); Trent A. Simpson, Peoria, IL (US)

(21) Appl. No.: 14/308,810

(22) Filed: Jun. 19, 2014

(51) Int. Cl. B25B 27/12

(52) U.S. Cl. CPC B25B 27/12
USPC 29/222

(57) ABSTRACT

A tool for removing a piston ring from a piston is provided. The tool includes a handle portion, an elongate portion, and a working portion. The elongate portion defines a longitudinal axis. The working portion includes a first section and a second section coupled to the first section at a pivot region. The first section is coupled to the elongate portion and is inclined at a first angle relative to the longitudinal axis. A retaining member protrudes from the first section. The second section includes a leading edge. A thickness of the second section decreases continuously from the pivot region to the leading edge and a width of the second section increases continuously from the pivot region to the leading edge. The working portion includes a ramp member extending from an upper surface of the second section. The ramp member includes an engaging surface to engage a piston ring.

### TECHNICAL FIELD

The present disclosure relates to a tool for removing a piston ring from a piston.

### BACKGROUND

Hand tools for replacing and/or removing piston rings from a piston are well known in the art. The hand tools typically engage a single piston ring at a time for its removal from the piston. The process of removal of a single piston ring at a time may be time consuming, and hence not suitable for removing rings from a large number of pistons. Further, the piston rings are resilient in nature, and thus have a tendency to spring-back during removal. Such spring-back may cause injury to the user of the hand tools during removal of the piston rings.

U.S. Pat. No. 1,354,034 discloses a piston ring tool. The piston ring tool is made of a single piece of metal. The said metal is bent upon itself and serves as a handle. The shank is flattened and comprises a stiff wide portion and narrower and substantially flexible end portion or blade. The blade has its edges sharpened which permits this portion to be readily inserted beneath the piston ring and drawn circumferentially around the piston to remove or apply the piston rings.

The piston ring tool as described in the U.S. Pat. No. 1,354,034 is configured to remove a single piston ring from a piston. Further, the piston ring tool lacks any safety measures to counter the spring-back demonstrated by piston rings during their removal from the piston. Furthermore, the tool as described in the U.S. Pat. No. 1,354,034 may not be able to remove piston rings made of strengthened materials.

### SUMMARY OF THE DISCLOSURE

In one aspect of the present disclosure, a tool for removing a piston ring from a piston is provided. The tool includes a handle portion and an elongate portion extending from the handle portion. The elongate portion defines a longitudinal axis. The tool further includes a working portion. The working portion includes a first section coupled to the elongate portion. The first section is inclined at a first angle relative to the longitudinal axis of the elongate portion. The working portion includes a retaining member protruding at an angle from the first section. The retaining member extends away from handle portion. The working portion further includes a second section coupled to the first section at a pivot region. The second section is inclined to the longitudinal axis at a second angle. The second section includes a leading edge distal from the pivot region. A thickness of the second section decreases continuously from the pivot region to the leading edge and a width of the second section increases continuously from the pivot region to the leading edge. The working portion further includes a ramp member extending from an upper surface of the second section away from the leading edge. The ramp member includes an engaging surface configured to engage a piston ring. Furthermore, a lower surface of the leading edge is curved upwards and a lower surface of the pivot region is curved upwards.

Other features and aspects of this disclosure will be apparent from the following description and the accompanying drawings.

### BRIEF DESCRIPTION OF THE DRAWINGS

FIG. 1 is a perspective view of a tool, according to an embodiment of the present disclosure;

FIG. 2 is a side view of a working portion of the tool of FIG. 1;

FIG. 3 is a perspective view of the working portion of the tool of FIG. 1;

FIG. 4 is a front view of the working portion of the tool of FIG. 1;

FIG. 5 is a rear view of the working portion of the tool of FIG. 1; and

FIG. 6 illustrates an exemplary operation of the tool of FIG. 1.

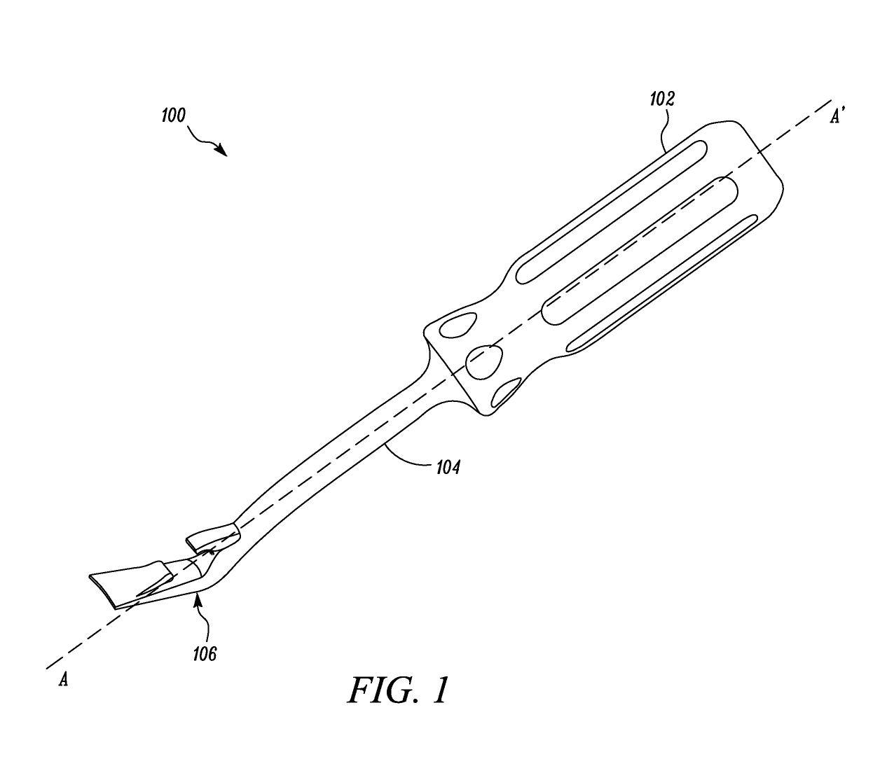

### DETAILED DESCRIPTION

Wherever possible, the same reference numbers will be used throughout the drawings to refer to the same or the like parts. FIG. 1 illustrates a perspective view of an exemplary tool 100, according to an embodiment of the present disclosure. The tool 100 includes a handle portion 102 and an elongate portion 104 extending from the handle portion 102. The handle portion 102 may be substantially hexagonal, square, or oval in cross-section. Further, the handle portion 102 may include various grip improving members, for example, recesses, protrusions, and the like, provided circumferentially along the handle portion 102. The handle portion 102 may be made of wood, metal, plastic or any other suitable material as commonly employed for manufacture of handles associated with hand tools.

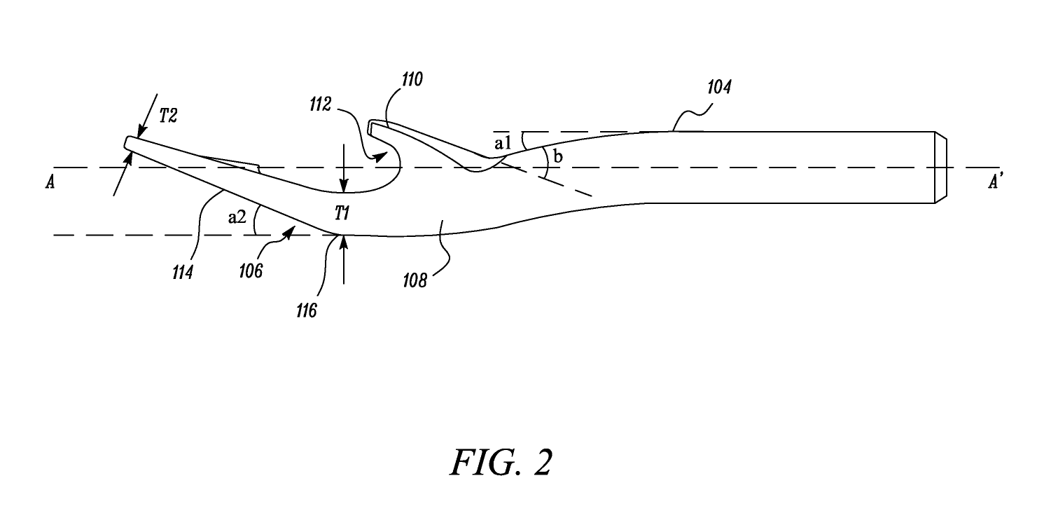

As illustrated in FIG. 1, the elongate portion 104 is substantially cylindrical. However, the elongate portion 104 may have any alternative cross-section, such as polygonal, elliptical, or the like. Further, the elongate portion 104 may be made of metal or metallic alloys. The elongate portion 104 defines a longitudinal axis A-A′. The longitudinal axis A-A′, as illustrated herein, is an imaginary line extending from the handle portion 102 through the elongate portion 104. The tool 100 further includes a working portion 106. Various details of the working portion 106 will be described hereinafter with reference to FIGS. 2 to 5.

FIG. 2 illustrates a side view of the working portion 106 of the tool 100 of FIG. 1. The working portion 106 includes a first section 108 coupled to the elongate portion 104. The first section 108 is inclined at a first angle (a1) relative to the longitudinal axis A-A′ of the elongate portion 104. For illustrative purpose, the first angle (a1) is shown with respect to a line parallel to the longitudinal axis A-A′. Further, a retaining member 110 protrudes from the first section 108. The retaining member 110 extends away from the handle portion 102 (shown in FIG. 1) and makes an angle (b) relative to the first section 108. The retaining member 110 and the first section 108 together define a catchment area 112 therebetween.

Further, a second section 114 is coupled to the first section 108 at a pivot region 116. The second section 114 is inclined to the longitudinal axis A-A′ at a second angle (a2). For illustrative purposes, the second angle (a2) is shown with respect to a line parallel to the longitudinal axis A-A′. The second section 114 includes a leading edge 118 distal from the pivot region 116. The pivot region 116 has a thickness (T1) and the leading edge 118 has a thickness (T2) such that the thickness (T1) is greater than the thickness (T2). Moreover, as illustrated in FIG. 2, a thickness of the second section 114 decreases continuously from the thickness (T1) at the pivot region 116 to the thickness (T2) at the leading edge 118.

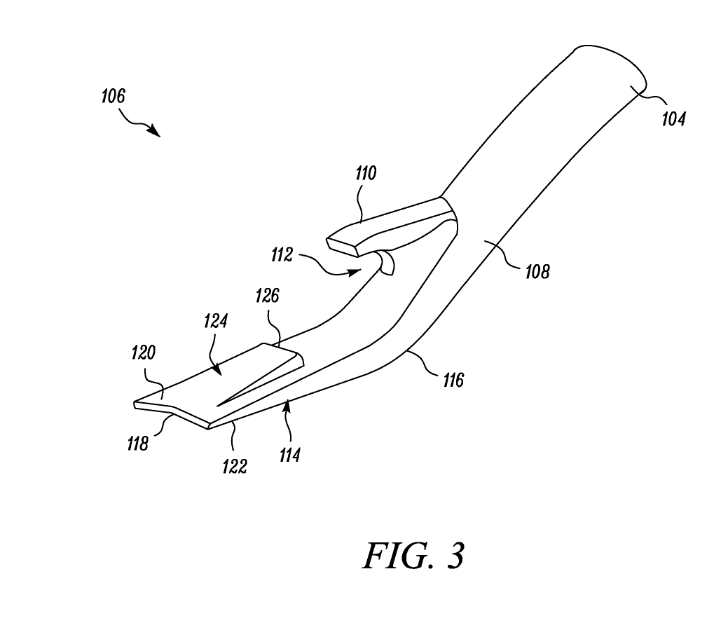

FIG. 3 illustrates a perspective view of the working portion 106 of the tool 100 of FIG. 1. The second section 114 further includes an upper surface 120 and a lower surface 122. A ramp member 124 extends from the upper surface 120 of the second section 114 away from the leading edge 118. With reference to FIGS. 2 and 3, the ramp member 124 includes an engaging surface 126. A thickness of the ramp member 124 gradually increases from the leading edge 118 to the engaging surface 124, i.e., the ramp member 124 has a minimum thickness at the leading edge 118 and a maximum thickness at the engaging surface 124.

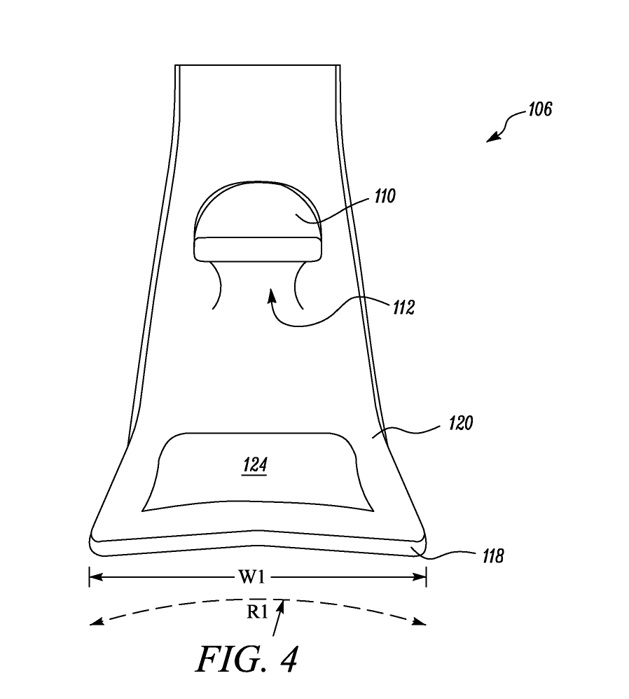

FIG. 4 illustrates a front view of the working portion 106 of the tool 100 of FIG. 1. The leading edge 118 has a width (W1). In an exemplary embodiment, the width (W1) may be 20 mm. Further, the lower surface 122 of the leading edge 118 may be curved upwards. In an exemplary embodiment, the lower surface 122 of the leading edge 118 may have a concave shape with a radius of curvature (R1). The radius of curvature (R1) may be about 65 mm.

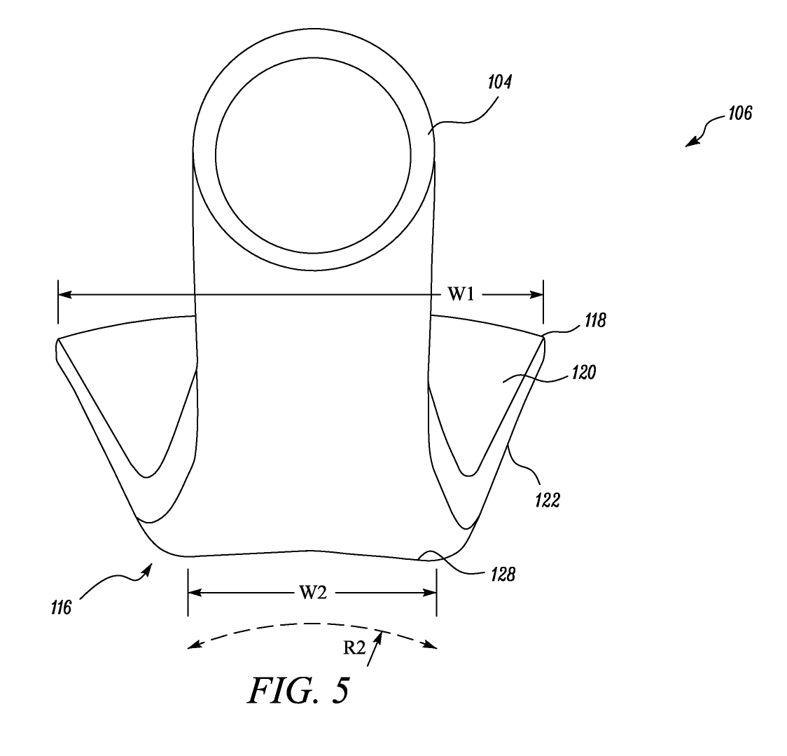

FIG. 5 is a rear view of the working portion 106 of the tool 100 of FIG. 1. The pivot region 116 has a width (W2). As illustrated in FIG. 5, a width of the second section 114 increases continuously from the width (W1) at the pivot region 116 to the width (W2) at the leading edge 118. Therefore, the width (W1) may be greater than the width (W2). Further, a lower surface 128 of the pivot region 116 may also be curved upwards. In an exemplary embodiment, the lower surface 128 of the pivot region 116 may have a concave shape with a radius of curvature (R2). In a further embodiment, the radius of curvature R1 may be substantially equal to the radius of curvature R2. Therefore, the radius of curvature (R2) may be about 65 mm.

In the previous embodiments it is disclosed that the lower surface 122 of the leading edge 118 and the lower surface 128 of the pivot region 116 may be curved upwards. However, in an alternative embodiment, the tool 100 may include a curved profile that may start from the lower surface 122 of the leading edge 118 and extend till the lower surface 128 of the pivot region 116. In an exemplary embodiment, a radius of curvature of this curved profile may be about 65 mm. Thus, a lower surface (not shown) of the second section 114 of the working portion 106 may be curved upwards.

From the foregoing it will be appreciated that, although specific shape and dimensions of the tool 100 have been described herein for purposes of illustration, various modifications or variations towards shape, and dimensions of the tool 100 may be made without deviating from the spirit or scope of the inventive feature claimed herein.

### INDUSTRIAL APPLICABILITY

A tool for removal of piston rings generally engages a single piston ring at a time for its removal from the piston. The tool may not safeguard a user from spring-back of the piston rings during removal.

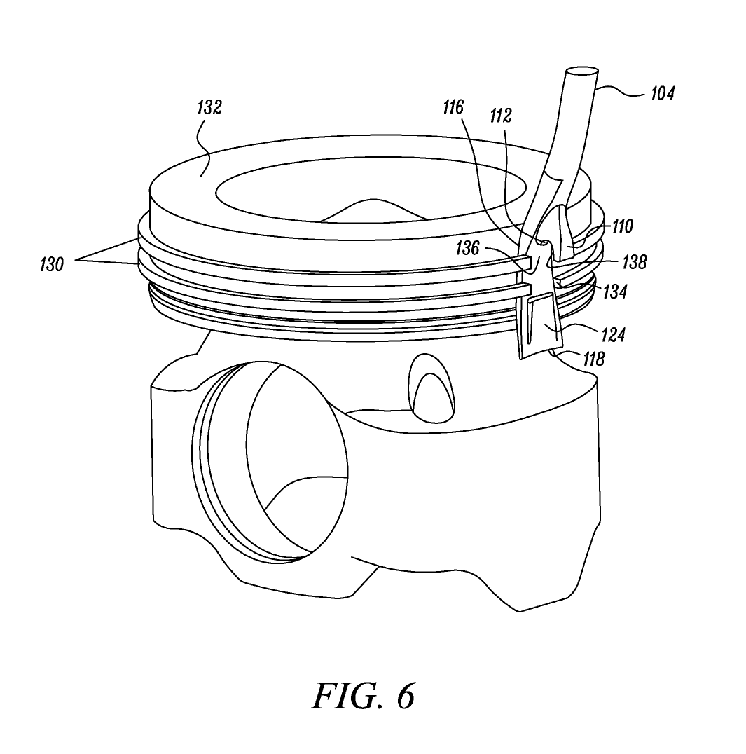

The present disclosure is related to the tool 100 for removing piston rings. FIG. 6 illustrates an exemplary operation of the tool 100 for removing a pair of piston rings 130 from a piston 132. As discussed in the foregoing disclosure, the thickness (T2) of the leading edge 118 is less than the thickness (T1) of the pivot region 116. Thus, the leading edge 118 may engage the piston rings 130 by easily slipping-in between the piston rings 130 and the piston 132. When the tools 100 is further pressed against the piston rings 130, the piston rings 130 may travel along the ramp member 124 to be captured by the engaging surface 126 of the ramp member 124.

When the tool 100 is engaged with the piston rings 130, the piston rings 130 slide over the second section 114. Further, the difference in the widths (W1>W2) of the leading edge 118 and the pivot region 116 may reduce a force required to disengage the piston rings 130 from the piston 132.

After the piston rings 130 are captured at the engaging surface 126, the pivot region 116 may be used as a fulcrum between the handle portion 102 and the second section 114 to allow a user to push the piston rings 130 farther away from the piston 132. Thus, together with the differences between the widths (W1>W2) and thicknesses (T1>T2), and the support provided by the pivot region 116, the piston rings 130 may be easily disengaged from the piston 130. Once the piston rings 130 are disengaged from the piston 132 and captured at the engaging surface 126, the user may pull the tool 100 to remove the piston rings 130 from the piston 132.

Referring to FIG. 3, the catchment area 112 is defined between the retaining member 110 and a catchment portion 136 such that the retaining member 110 forms a support portion 138 for the piston rings 130. Thus, during removal of the piston rings 130, if the piston rings 130 spring-back then the catchment area 112 may limit the travel of the piston rings 130 towards the elongate portion 104 and allows for safe removal of the piston rings 130 from the piston 132. As discussed herein, it will be appreciated by a person ordinarily skilled in the art that with the tool 100 of the present disclosure, a plurality of piston rings 130 may be removed from the piston 132 simultaneously. Thus, the tool 100 decreases cycle time for replacement of piston rings 132 from the piston 130.

With reference to FIGS. 4 and 5, the lower surface 122 of the leading edge 118 and the lower surface 128 of the pivot region 116 are curved upwards. The higher width (W2) of the leading edge 118 may lead to lower stress concentration when engaged with the piston rings 130. The upward curvature of the lower surfaces 122, 128 may improve stress distribution in the working portion 106 and reduces wear at the leading edge 118 and the pivot region 116, respectively. Thus, a life of the tool 100 is also improved. Hence, the tool 100 may be employed for removal of a wide variety of piston rings having increased strengths. Further, the upward curvature of the pivot region 116 may prevent damage to a surface of the piston 132.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A tool for removing a piston ring from a piston, the tool comprising:
a handle portion;
an elongate portion extending from the handle portion, the elongate portion defining a longitudinal axis; and
a working portion including:
a first section coupled to the elongate portion, wherein the first section is inclined at a first angle relative to the longitudinal axis of the elongate portion;
a retaining member protruding at an angle from the first section, wherein the retaining member extends away from handle portion;
a second section coupled to the first section at a pivot region, wherein the second section is inclined to the longitudinal axis at a second angle, and wherein the second section includes a leading edge distal from the pivot region;
wherein a thickness of the second section decreases continuously from the pivot region to the leading edge, and wherein a width of the second section increases continuously from the pivot region to the leading edge; and
a ramp member extending from an upper surface of the second section away from the leading edge, wherein the ramp member includes an engaging surface configured to engage a piston ring;
wherein a lower surface of the leading edge is curved upwards; and
wherein a lower surface of the pivot region is curved upwards.
